(19) United States
(12) Patent Application Publication
(10) Pub. No.: US 2006/0188710 A1
(43) Pub. Date: Aug. 24, 2006

(54) PAD WITH SELECTIVELY ACTIVATED ADHESIVE

(76) Inventors: David C. Windorski, Woodbury, MN (US); Ashish K. Khandpur, Lake Elmo, MN (US); Manisha Sarkar, Austin, TX (US); Lori Bilski, Woodbury, MN (US)

Correspondence Address: 3M INNOVATIVE PROPERTIES COMPANY, PO BOX 33427, ST. PAUL, MN, 55133-3427, US

(21) Appl. No.: 11/276,208

(22) Filed: Feb. 17, 2006

Related U.S. Application Data
(63) Continuation-in-part of application No. PCT/US05/03594, filed on Feb. 4, 2005.
Application No. PCT/US05/03594 is a continuation-in-part of application No. 10/772,190, filed on Feb. 4, 2004.

(51) Int. Cl. B32B 7/00

(52) U.S. Cl. 428/343

(57) ABSTRACT

The inventive pad has a plurality of sheets stacked on top of one another. Each sheet having opposing, writeable first and second surfaces, opposing upper and lower edges, and opposing first and second side edges. A securing mechanism is disposed on the second surface and proximate to the upper edge of the sheet. The securing mechanism includes (a) first and second raised elements and (b) a pressure sensitive adhesive. Each element has an application surface and is aligned generally parallel to and spaced apart from one another. The adhesive has an exposed surface and is disposed between the first and second raised element. The height of the adhesive, as measured from its exposed surface to the second surface is shorter than the height of either raised element, as measure from its application surface to the second surface. The sheets are attached together forming the pad.

### CROSS-REFERENCE TO RELATED APPLICATIONS

This application is a continuation-in-part of International Application No. PCT/US2005/003594 filed on Feb. 4, 2005, which is a continuation-in-part of U.S. application Ser. No. 10/772,190 filed on Feb. 4, 2004. This application is also related to U.S. application having a docket number of 61772US002, filed on even date herewith.

### FIELD OF INVENTION

The present invention relates to a pad of sheet material. In particular, the present invention relates to a pad where each sheet has a selectively activated adhesive to allow for ease of using and restacking sheets in the pad.

### BACKGROUND

Pads, such as Post-it® 559 Easel Pad from 3M Company, St. Paul, Minn. have become established communication tools for use in wide variety of settings, such as, e.g., in meetings, in classrooms, and as part of presentations. Because sheets in the easel pad are relatively large (e.g., about 2 feet by 3 feet) and because each sheet in the pad can be separated from the pad and displayed on a substrate, such as a wall, pads have gained much popularity.

FIGS. 10 and 11 show one illustrative embodiment of prior art easel pad 10 having plurality of sheets 12a to 12d. For ease of discussion, only four sheets are shown. Each sheet has opposing front and back surfaces and an adhesive coated on a portion of the back. For example, first sheet 12a has writeable front surface 16a and opposite back surface 14a upon which adhesive 18a is disposed. Typically, the adhesive is repositionable, meaning that it can be attached to a substrate, removed, and reattached to the substrate again multiple times. As shown in FIG. 11, in a gathering such as a meeting, when a user fills up first sheet 12a during an activity such as a meeting, she can flip it over the pad so as to access second sheet 12b. The surface area of front surface 16b that lies underneath adhesive 18a, however, is not easily accessible to the user. In one typical application, after the user fills up the first sheet, she removes it completely from the pad and displays it on a surface, such as, e.g., a wall. She continues to fill as many sheets as necessary removing and displaying them as she completes each sheet. At the end of the meeting, the user collects all of the displayed sheets and, typically organizes them in a stack. Because of the presence of adhesive 18, the sheets in the stack will be adhesively attached to one another in the stack, whether the user intended them to be or not. Upon removal of the stack, e.g., if the user wants to transcribe the notes into an electronic medium, the user most likely will have to either peel away each sheet, or again flip the sheets.

While the foregoing pads and other commercially available pads are useful, other user friendly pad designs are needed.

### SUMMARY

The present invention addresses the problems of prior art pads in that it provides more surface area on the sheets for the user and it allows for easy stacking and manipulation of the sheet once detached from the pad. The sheets in the pad of the present invention do not need a liner to protect the securing mechanism or the sheet itself. However, a liner can be used, if desired. The pads of the present invention can be used as easel pads, drawings or sketching pads, and as large format (e.g., 8½ by 11 inch) note pads for meetings, seminars, and the like.

In one aspect, the present invention relates to a pad comprising (i) plurality of sheets stacked on top of one another, each sheet having opposing, writeable first and second surfaces, opposing upper and lower edges, and opposing first and second side edges; (ii) a securing mechanism disposed on the second surface and proximate to the upper edge of each sheet, the mechanism comprising (a) first and second raised elements, each having an application surface and aligned generally parallel to and spaced apart from one another, and (b) a pressure sensitive adhesive having an exposed surface and disposed between the first and second raised element, wherein the height of the adhesive, as measured from its exposed surface to the second surface is shorter than the height of either raised element, as measured from its application surface to the second surface; and (iii) a means for attaching the plurality of sheets together.

In another aspect, the present invention relates to a pad comprising a plurality of sheets in a stack, each sheet having opposing writeable first and second surfaces, opposing upper and lower edges, and opposing first and second sides and a selective adhesion mechanism disposed on the second side of the sheet, the selective adhesion mechanism comprising: (i) first and second raised elements disposed proximate to the upper edge of the sheet and generally parallel to and spaced apart form one another, each raised element having an application surface; and (ii) a repositionable pressure sensitive adhesive having an exposed surface and disposed between the first and second raised elements, wherein the height of the adhesive, as measured from the exposed surface of the adhesive to the second surface of the sheet is shorter than the height of either the first or the second raised element, as measured from the its application surface to the second surface of the sheet, and wherein the first and second raised element and the adhesive are continuous from the first side to the second side edge of the sheet.

In the pad construction of the present invention, the first surface of each sheet is that side that is directly accessible to the user, as she faces the pad. That is to say, as the pad is placed on, e.g., an easel stand, the first surface of a first sheet is that which is in direct line of sight of the user, while the second surface is not accessible until the user flips the sheet over or otherwise removes the sheet from the pad thereby exposing both first and second surfaces.

The pad of the present invention includes a pressure sensitive adhesive that is exposed on a portion of the second surface of the sheet. The adhesive is effectively recessed by means of one or more raised elements that extend from the sheet to a height greater than the height of the exposed face of the adhesive thereon.

When the sheet has its second surface abutting another surface, such as another sheet, it will not adhere thereto because the pressure sensitive adhesive thereon is spaced from that surface. When a threshold level of pressure is applied to the first side of the sheet, opposite the pressure sensitive adhesive thereon, the sheet bearing the adhesive is sufficiently flexible and deformable so that at least a portion of the exposed adhesive is brought into abutting engagement with the surface to adhere thereto without collapsing the raised element.

The threshold level of pressure would typically be manual, such as by pressing against the first surface of the sheet with a hand, fingers, or palm of the hand. This activation of the securing mechanism by the user provides adhesion “on demand”, i.e., adhesion at the time the user wants adhesive properties. This external applied pressure (i.e., compressive force) would typically be exerted in a direction substantially normal to the first side of the sheet. This pressure creates an adhesion peel force of the adhesive to the surface after activation that is greater than the adhesion peel force (which is substantially zero) before activation by the user and which is sufficient to adhere the sheet to the surface.

In this document, the term “upper” and “lower” edges and any other terms that relate to orientation are used to indicate relative positions. All numerical terms in this document are presumed to be modified by the term “about”.

### BRIEF DESCRIPTION OF THE DRAWINGS

The invention can be further described with reference to the following figures, wherein:

FIG. 1 is a perspective view of a pad of the present invention;

FIG. 2 is top plan view of one sheet in the pad of FIG. 1, as viewed from the second surface;

FIG. 3A is a sectional view as taken along line 3-3 in FIG. 2;

FIG. 3B is a sectional view of the sheet of FIG. 2, showing its adherence to a vertical surface of a substrate;

FIG. 4 is a sectional view of a plurality of sheets in a pad of the present invention;

FIG. 5 is a sectional view of the pad of FIG. 4 where one sheet has been flipped over;

FIG. 6 is a sectional view of another embodiment of the present invention;

FIG. 7 is a sectional view of another embodiment of the present invention;

FIG. 8 is a top plan view of another embodiment of the present invention as viewed from the second surface of the sheet;

FIG. 9 is a top plan view of another embodiment of the present invention as viewed from the second surface of the sheet;

FIG. 10 is a sectional view of a plurality of sheets in an easel pad in the prior art; and

FIG. 11 is a sectional view of the prior art easel pad of FIG. 10 where one sheet has been flipped over.

These figures are illustrative and are not drawn to scale. While the above drawing figures show several embodiments of the present invention, other embodiments are also contemplated, as noted in this disclosure. This disclosure presents the invention by way of representation and not limitation. Other modifications and embodiments can be devised by those skilled in the art that fall within the scope and spirit of the principles of the invention.

### DETAILED DESCRIPTION

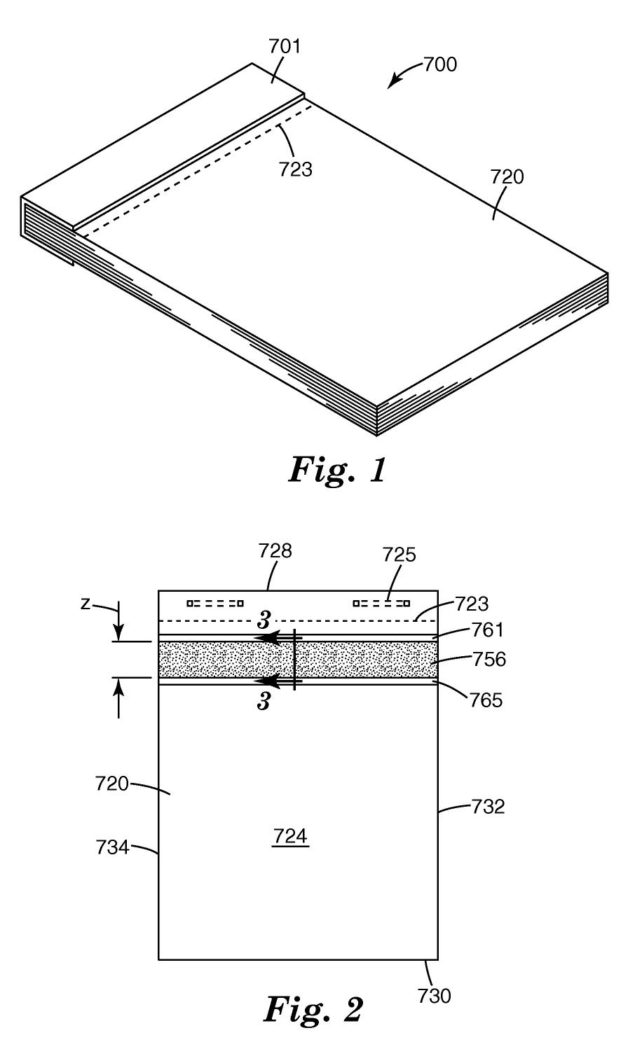

FIG. 1 is a perspective view of a pad of the present invention. Pad 700 includes a plurality of sheets 720 stacked and attached together at end 701. Each sheet in the pad may include perforation 723 proximate to end 701. As will be further explained below, each sheet includes a securing mechanism located proximate to end 701.

FIG. 2 shows a bottom plan view of one sheet of the pad. Sheet 720 has opposing upper edge 728 and lower edge 730, and opposing first side edge 732 and second side edge 734. Each sheet also has opposing first surface (not shown) and second surface 724, both surfaces being writeable. The sheet includes a securing mechanism disposed on second surface 724 of the sheet and proximate to the upper edge. The securing mechanism includes pressure sensitive adhesive 756 disposed between first raised element 761 and second raised element 765. The distance between the first and second raised element is denoted as spacing Z. In this particular embodiment, the first raised element is elongated, generally linear, and lies proximate to the upper edge of the sheet. While the embodiment in FIG. 2 shows the pressure sensitive adhesive and the first and second raised element to be substantially continuous stripes extending across the width of the sheet, other configurations can be used, as described in the various embodiments discussed below. The sheet further includes perforation 723 disposed between the first raised element and the upper edge. The sheets in the pad are attached together using mechanical means, such as staples 725.

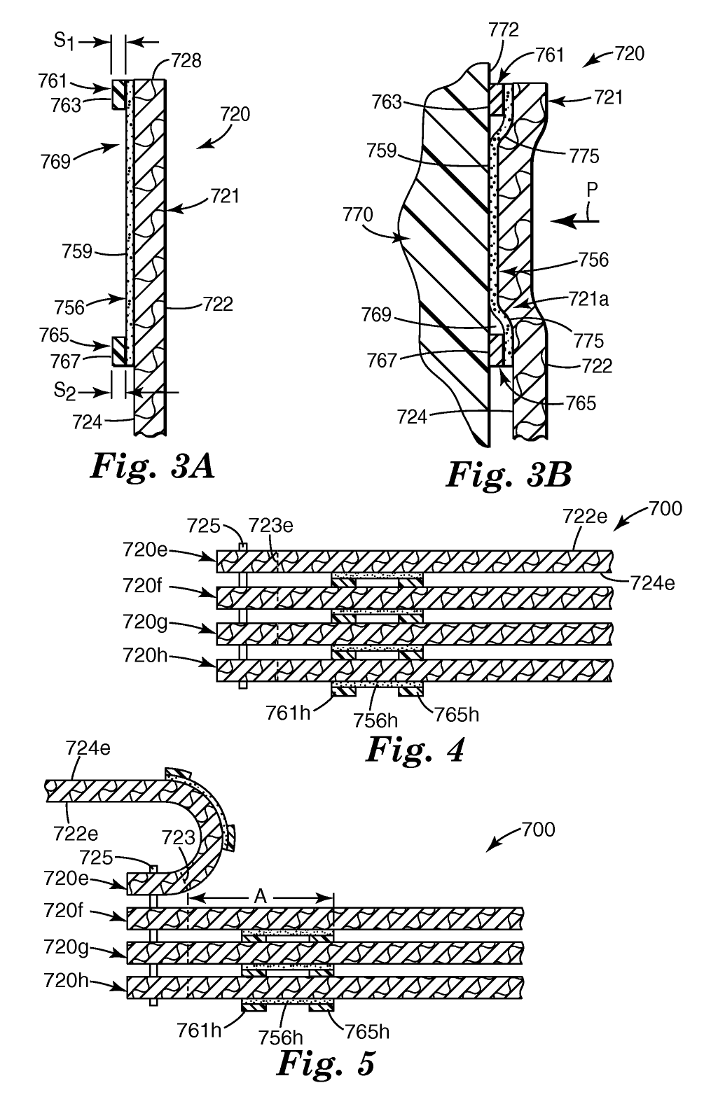

FIG. 3A is a cross-sectional view of the sheet of FIG. 2 taken along line 3-3. In this embodiment, first raised element 761 and second raised element 765 are adhered to exposed surface 759 of pressure sensitive adhesive 756. The first raised element has a first application surface 763 and the second raised element has second application surface 767. The distance from first application surface 763 or from second application surface 767 of each element to second side 724 of the sheet is greater than the distance from exposed surface 759 of the pressure sensitive adhesive to backside 724 of the sheet. As shown, first and second raised elements project outwardly from the exposed surface of the adhesive a standoff distance S₁ and S₂ respectively. In one embodiment, S₁ is equal to S₂, although they do not have to be equal.

Standoff distances S₁ and S₂ are sufficient to space or separate exposed surface 759 of adhesive 756 on second surface 724 of the sheet from contacting an adjacent surface allowing the sheet to be handled and moved across the adjacent surface without adhering thereto by adhesive 756. Exemplary adjacent surfaces include, but are not limited to, another sheet, a desktop, or a wall. Thus, contact by the sheet with the adjacent surface is via the first and second raised elements and the portion of second surface 724 of the sheet that is free of adhesive. The first and second raised elements effectively provide borders for recess zone 769 therebetween where the exposed surface 759 of adhesive 756 is disposed.

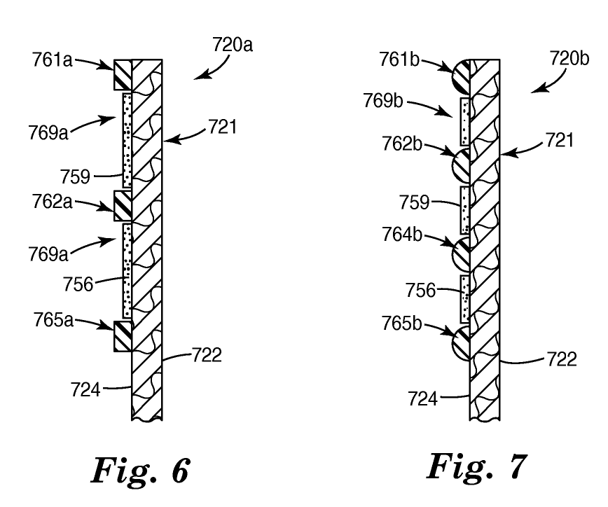

As seen in FIG. 3B, substrate 770 has mounting surface 772. The standoff distances S₁ and S₂ prevent the adherence of exposed surface 759 of adhesive 756 in recess zone 769 with mounting surface 772 in the absence of a threshold level of pressure applied against front side 722 of the sheet opposite adhesive 756. When a threshold level of pressure is applied, however, sheet 720 is sufficiently flexible and deformable so that at least a portion of exposed surface 759 of adhesive 756 contacts mounting surface 772 and adheres thereto. The pressure applied would typically be manual, such as by pressing against front side 722 of sheet 720 with the fingers, palm, or hand of a user, in a direction generally denoted as P. While adhesive 756 is activated to retain the sheet to the substrate, the sheet may deform on its front side, although the deformation may not be visually or tactilely appreciable to the user. The first and second raised elements may, under pressure P, compress slightly, but still retain sufficient height to space the sheet from the mounting substrate. Thus, when the securing mechanism is activated, the raised elements do not collapse. Although FIGS. 2, 3A and 3B show a first and second raised element, in some embodiments, three or more raised elements may be desired, as shown and further described in FIGS. 6 and 7.

FIG. 4 shows a cross sectional view of a plurality of inventive sheets stacked together to form a pad. In one embodiment, a backing, such as a cardboard backing (not shown), is placed on the second side of the last sheet in the stack, here represented as sheet 720h. The plurality of sheets is stacked such that a first sheet is disposed on a subsequent sheet such that second side 724e of first sheet 720e is proximate to first side 722e of the subsequent sheet such that securing mechanism associated with sheet 720e is disposed on the first side of subsequent sheet 720f.

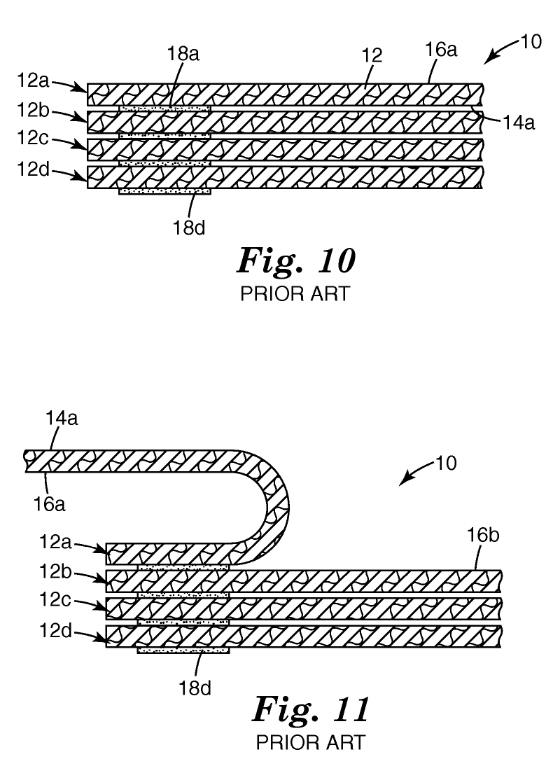

As stated earlier, typically, in a normal course of using a pad, the user transcribes information on a first sheet and he may flip it over, as shown in FIG. 5, thereby exposing a subsequent sheet for use. As the first sheet is flipped over the pad the securing mechanism associated with the first sheet is also flipped. As a result, zone A, which is the zone on sheet 720f that lies below the securing mechanism of sheet 720e is available for use. Thus, substantially the entire first surface of subsequent sheet 720f is available for use. In contrast, as compared to FIG. 10, which is a prior art pad, the surface area of the subsequent sheet 12b that lies underneath the adhesive 18a is not easily available for use.

Another typical use of an easel involves removing the transcribed sheet from the pad entirely, typically by peeling it from the pad, or by tearing along perforations that have been provided on the sheet. The user can then display the transcribed sheet on a substrate, such as, e.g., a wall. This type of behavior is more common when the user, typically working in a group setting such as a meeting, wants to have other members in the group see what has been transcribed. At the end of the meeting, the user would most likely collect all of the displayed sheets and restacks them into a pile. Because of the securing mechanism, the displayed sheets will not adhere to one another unless a threshold pressure is applied to the securing mechanism. This feature differs from that of the prior art pads that uses a repositionable adhesive on the second surface. For example, with reference to FIGS. 10 and 11, when a sheet of the prior art easel is removed from the pad, and then subsequently restacked, it is likely that the restacked sheet will adhere to one another because of adhesive 18.

FIG. 6 is a cross-sectional view of another embodiment of the present invention, similar to the one taken along line 3-3 of FIG. 2. First raised element 761a and second raised element 765a are not adhered to the adhesive 756, but are bonded directly to the second side 724 of sheet 720a. This embodiment further includes third raised element 762a disposed substantially equidistant between the first and second raised elements. As the distance of the zone of adhesive Z increases, more than two raised elements can be used for the securing mechanism. The securing mechanism of the sheet of FIG. 6 functions in substantially the same manner as described above, because the three raised elements function to define recess zones 769a for adhesive 756 and serve to space and to standoff the exposed surface 759 of the adhesive from a substrate or the surface of an adjacent sheet.

FIG. 7 is a cross-sectional view of another embodiment of the present invention similar to the one taken along line 3-3 of FIG. 2. This embodiment includes four raised elements, 761b, 762b, 764b and 765b spaced so as to create three substantially equal distance recess zones. The raised elements are each formed by a bead of material that has been deposited on the second side 724 of sheet 720b. The bead may be deposited over the adhesive, like that shown in FIG. 3A, or adjacent thereto, as shown in FIG. 7. Each bead has an application surface, which is the surface that is furthest away from exposed surface 759 of the adhesive. The distance from the application surface to the exposed surface 759 defines the standoff distance. The standoff distance for each bead is a distance sufficient to space the exposed surface 759 of the adhesive in recess zones 769b from another surface contacting the second side 724 of the sheet in the absence of an application of a threshold level of pressure. The securing mechanism of sheet 720b functions in substantially the same manner as described above.

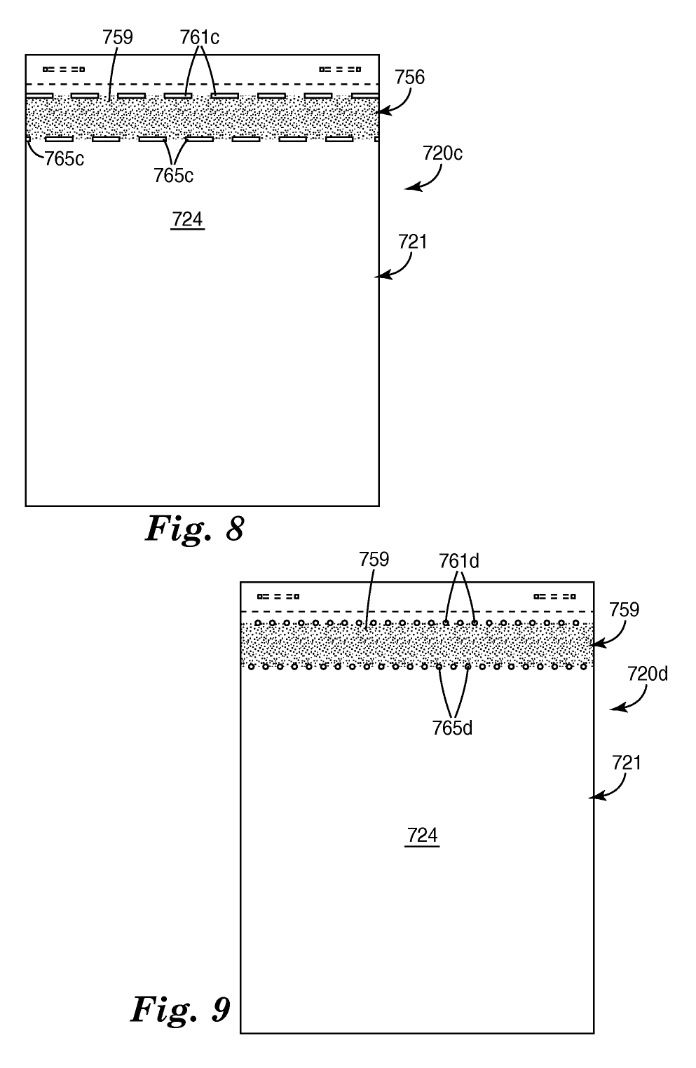

FIG. 8 is a top plan view of the second surface of another embodiment of the present invention. Sheet 720c has on its second surface 724 first raised elements 761c and second raised elements 765c in the form of discontinuous strips or separated segments. In yet another embodiment, a combination of continuous and discontinuous strips can be used. First and second raised elements 761c and 765c can be aligned over adhesive 756 or proximate thereto, and although discontinuous, are aligned in a generally linear and parallel to one another. The separated segments of the first and second raised elements may be of the same length or of different length, so long as the raised elements serve the function of providing the standoff distance necessary to prevent unintended adhesion of the exposed surface 759 of adhesive 756 but still provide the “on demand” adhesive characteristic for sheet 720c.

FIG. 9 is a bottom plan view of another embodiment of the present invention showing discontinuous strips of first and second raised elements, 761d and 765d respectively, in the form of a plurality of discrete drops or beads. The raised elements are aligned in a generally linear and parallel arrangement with the adhesive disposed in recess zone 769d. The discrete drops may be deposited in liquid form and then hardened or cured upon exposure to ambient conditions at a height that provides the requisite standoff distances for the first and second raised element relative to the exposed surface 759 of the adhesive. In this way, the “on-demand” characteristic provided by the securing mechanism is achieved.

The sheet should be of a material that deforms so as to allow the adhesive in the securing mechanism to overcome the recess defined for it and to contact the target substrate. The sheet should also be sufficiently flexible to allow for such contact and then resilient enough to resume its substantially original shape to allow the recess to be redefined once the sheet has been removed from the target substrate. Suitable examples of sheet materials include, but are not limited to, paper, plastic, dry erase polymer film, canvas, fabric, and combinations thereof. In one embodiment, the sheet is about 6 to 30 inches in width and about 10 to 50 inches in length. The sheet can have a thickness of 0.001 inch to 0.10 inch. As stated, in some embodiment, the portion of the first side of the sheet that comes into contact with the securing mechanism of the previous sheet can include coating that is ink receptive and has release properties. The ink receptive properties allows the sheet to accept writing or be imaged using a digital imaging device. In some embodiments, the sheet includes ink receptive coating coated on substantially the entire first and second surface. Suitable ink receptive coatings that exhibit release properties include those disclosed in U.S. Pat. Nos. 5,716,685 and 5,874,144.

Pressure sensitive adhesives (PSA) are known to those skilled in the art. In general, a PSA has properties, such as, aggressive and permanent tack, adherence to a surface with no more than finger pressure, sufficient ability to hold onto an adherend, and sufficient cohesive strength.

In one embodiment, the pressure sensitive adhesive is a repositionable pressure sensitive adhesive. Suitable repositionable adhesives are disclosed in U.S. Pat. Nos. 3,691,140 (Silver); 3,857,731 (Merrill et al.); 4,166,152 (Baker et al.); 4,495,318 (Howard); 5,045,569 (Delgado); 5,073,457 (Blackwell); 5,571,617 (Cooprider et al.); 5,663,241 (Takamatsu et al.); 5,714,237 (Cooprider et al.); U.S. RE 37,563 (Cooprider et al.); 5,756,625 (Crandall et al.) and 5,824,748 (Kesti et al.). The repositionable adhesive can be solvent based, water based, or can be a solventless, hot melt adhesive.

The raised elements can be made from a variety material. Suitable examples include applying ultraviolet (UV) curable or water based coatings, which would form the raised elements. For example, some curable coatings can self cure or are exposed to ultraviolet radiation for curing. Typically, water based coatings are dried in a conventional oven to evaporate the water. Another suitable material for the raised element is tape, where the adhesive side of the tape is disposed on the pressure sensitive adhesive or the second side of the sheet. It is desirable for the raised elements to leave substantially no residual mark on the target substrate to which the sheet is attached. Suitable standoff distance for the raised elements ranges from 0.0005 to 0.01 inch. The spacing between one raised element and subsequent raised element is between 0.25 to 2.0 inch.

The plurality of sheets is attached together to form the inventive pads. The sheets can be attached using any suitable means, including, but not limited to mechanical means, adhesive means, and binding means. Suitable mechanical means would include, but are not limited to, using a plurality of staples. Suitable adhesive means would include, but are not limited to, using a repositionable adhesive adjacent to the upper edge of the sheet. Suitable binding means would include, but are not limited to, a binding compound used to at the upper edge of the sheet forming the pad.

### EXAMPLES

Flip Force Test Method

The flip force is the force required to pull a sheet off a pad as the sheet is being flipped over the pad. The flip force was measured in the following way. All testing was conducted on pads in a controlled temperature and humidity environment of 72° F. and 50% relative humidity (RH). Each sample pad with 30 sheets in stack was placed flat on a table. The first two sheets of the pad were discarded prior to testing. A force gauge was attached to the center of the free end of a top sheet in the pad. The top sheet was then lifted up at a speed of approximately 12 inches per second at an angle of about 90 degrees between the first sheet and subsequent sheets in the pad. The maximum force required to lift the sheet off the pad was recorded when the sheet was lifted off of the securing mechanism for that sheet. Three such readings were taken from three individual samples to get an average.

Wall Hang Test Method

Individual sheets were removed from the pad and applied to various vertical test surfaces to get a measure of its “wall hang” performance. Test surfaces used included typical vertical surfaces in an office, and included the following: (1) painted sheet rock or dry wall, (2) office cubicle fabric, and (3) office meeting room vinyl. Before each wall hang test, the surface was cleaned with isopropanol to remove any possible debris or residue from the surface. The sheets were removed from the pad along the perforation and applied to the test surface, securing it in position by applying firm hand pressure over the repositionable adhesive stripe on the sheet in two passes. The sheet was left on the surface for 7 days or until it falls. The time for sheet to fall to ground was measured in days and the test was stopped after 7 days (test value denoted as 7+ days).

Construction of a Pad

Each pad was formed from 30 sheets of paper stacked on each other, adhesive side (i.e., second side) of one sheet contacting the release side (first side) of the successive sheet. Each sheet measured 18.5 inch (width) by 20 inch (length). The pad was formed such that the adhesive stripe, the first and second raised element ran continuously across the entire sheet width, similar to the embodiment shown in FIG. 2. The top 0.5 inch of the sheet adjacent to the upper edge of the sheet was uncoated. A perforation was also made during a converting process such that it ran through the width of each of the sheets just above the adhesive stripe. Each sheet had the following construction on its second surface: uncoated paper at the top 0.5 inch, followed by a 2 inch coating of adhesive, followed by a 17.5 inch uncoated paper. A 18.5 inch wide and 22 inch long corrugated back-card was then placed at the back of the pad of sheets for support and the pad of sheets were stapled to it through use of three staples across the pad width and just above the perforation line. In some embodiments, the first and second raised elements were coated directly on to the adhesive, while in other embodiments, they were coated on the second side of the sheet proximate to the adhesive. The location of the raised elements is specifically noted in each example.

### EXAMPLES 1 to 6

A pre-coated roll was made by taking a roll of paper (basis weight of 18.5 lb/1300 ft²) available from Boise, International Falls, Minn. approximate 20 inches in width and coating a 2-inch wide repositionable adhesive stripe, the adhesive as described in U.S. Pat. No. 5,571,617. The stripe was coated along the length of the roll on a second side of the paper. The adhesive was coated with a 0.5 inch offset from one edge of the roll. On the first side of the paper, an ink receptive coating as described in U.S. Pat. Nos. 5,716,685 and 5,874,144 was coated in generally the same area as the adhesive. These ink receptive coatings also had release properties, to allow for release of the adhesive on the prior sheet.

The pre-coated roll was fed into a flexographic press (model 4120 from Mark Andy Inc., St. Louis, Mo.), where two stripes, each being 0.1875 inch wide, were printed on the repositionable adhesive and then cured by exposing the stripes to two, 400 watts mercury bulbs, available from Aetek UV Systems, Inc., Romeovilled, Ill., to yield a coated roll having a securing mechanism. The line speed for the printing and curing was 100 feet per minute (fpm). The raised elements were made from ultraviolet light curable solution, commercially available as XSYS 2415, from XSYS Printing Solutions, Plymouth, Minn.

Individual sheets were cut from the coated roll, each sheet measuring 18.5 inches in width and 20 inches in height. For each pad, 30 sheets were stacked so that the adhesive and raised element stripes were aligned generally in the same area from sheet to sheet. The sheets were mechanically attached together by using three staples running across the width of the sheet between an upper edge and the adhesive stripe.

While examples 1 to 6 used the same adhesive and raised elements, the number of raised elements and their standoff height was varied according to the data in Table 1. The raised element height was measured using a caliper gauge and by subtracting the thickness of the sheet and adhesive from the total thickness of the sheet, adhesive, and raised element.

### COMPARATIVE A

A comparative sample was made according to Example 1, except that no raised element was coated on to the pre-coated roll.

### EXAMPLES 7 TO 10

Examples 7 to 10 exemplified examples where the raised elements were made from waterbased coatings. Also, a four station flexographic press was used to achieve the raised element height. The water based coatings were dried using infrared heaters such that the localized web temperature proximate to the heaters was 215° F.

Examples 7 and 8 used a commercially available 45% solids acrylic resin, product designation Carboset GA-2137, from Noven, Inc., Cleveland, Ohio. Example 7 used 18 pound paper from Boise, International Falls, Minn. Example 8 used a dry erase film, about 0.003 inch in thickness), from Protect-all, Darien, Wis.

Examples 9 and 10 used a commercially available coating, product designation Overprint WVL 02046 and HMF 00063 respectively, both from XSYS Print Solutions, Plymouth, Minn.

Table 1 summarizes the number or raised elements used, and the height of the raised elements.

### EXAMPLE 11

Example 11 was made according to examples 1 to 6, except that tape, product number 351, commercially available from 3M Company, St. Paul, Minn. was used as the raised elements. Three equally spaced strips of the 351 tape were laminated to the pre-coated roll of Examples 1 to 6. The tape strips were laminated by adhering the adhesive side of the 351 tape to the repositionable adhesive on the sheet and using four passes of 100 gram wall paper roller over each strip.

TABLE 1

| | Raised | | | | | |
|---|---|---|---|---|---|---|
| | Element | No. of | | Wall | Wall | Wall |
| | Height | Raised | Flip Force | Hang | Hang | Hang |
| Example No. | (mil) | Elements | (grams) | dry wall | vinyl | fabric |
| Comparative A | 0 | 0 | 406 | 7+ | 7+ | 7+ |
| 1 | 0.5 | 2 | 50 | 7+ | 7+ | 7+ |
| 2 | 0.5 | 3 | 27 | 7+ | 7+ | 7+ |
| 3 | 1.0 | 2 | 37 | 7+ | 7+ | 7+ |
| 4 | 1.0 | 3 | 23 | 7+ | 7+ | 7+ |
| 5 | 2.0 | 3 | 25 | 7+ | 7+ | 7+ |
| 6 | 2.0 | 4 | 31 | 7+ | 7+ | 7+ |
| 7 | 0.5 | 3 | 41 | 7+ | 7+ | 7+ |
| 8 | 1.1 | 3 | 124 | 7+ | 7+ | 7+ |
| 9 | 0.3 | 3 | 30 | 7+ | 7+ | 7+ |
| 10 | 0.4 | 3 | 45 | 7+ | 7+ | 7+ |
| 11 | 3.5 | 3 | 23 | 7+ | 7+ | 7+ |

The data in Table 1 shows that in each of the inventive examples (1 to 11) where a securing mechanism was used, the flip force needed to peel a sheet from a pad is significantly less than the force required to peel off a sheet that did not have a securing mechanism. Additionally, even with the securing mechanism, the inventive examples had the same performance in wall hang as the comparative example, which means that the use of the securing mechanism did not appreciably affect the adhesion performance of the sheet on the various substrates listed above.

What is claimed is:

1. A pad comprising:
a plurality of sheets stacked on top of one another, each sheet having opposing, writeable first and second surfaces, opposing upper and lower edges, and opposing first and second side edges;
a securing mechanism disposed on the second surface and proximate to the upper edge of the sheet, the mechanism comprising (a) first and second raised elements, each having an application surface and aligned generally parallel to and spaced apart from one another, and (b) a pressure sensitive adhesive having an exposed surface and disposed between the first and second raised element, wherein the height of the adhesive, as measured from its exposed surface to the second surface is shorter than the height of either raised element, as measured from its application surface to the second surface; and
a means for attaching the plurality of sheets together.

2. The pad of claim 1, wherein in the absence of a threshold level of pressure applied to the securing mechanism, the pressure sensitive adhesive is spaced from a substrate and when a threshold level of pressure is applied to the securing mechanism, the adhesive comes into securing engagement with the substrate without collapsing the raised elements.

3. The pad of claim 1, wherein the first and second raised element is disposed on the adhesive or the second surface of the sheet.

4. The pad of claim 1, wherein the securing mechanism spans continuously across the sheet from the first side edge to the second side edge of the sheet.

5. The pad of claim 1, wherein the adhesive is a repositionable adhesive.

6. The pad of claim 1, wherein at least one of the first and second raised element is selected from the group consisting of a continuous strip, a discontinuous strip, a bead, a plurality of beads, and combinations thereof.

7. The pad of claim 1, wherein the sheet is selected from the group consisting of paper, plastic, dry erase polymer film, canvas, fabric, and combinations thereof.

8. The pad of claim 1, wherein the means for attaching the sheets together is selected from the group consisting of mechanical means, adhesive means, and binding means.

9. The pad of claim 1 further comprising a perforation in the sheet, the perforation being disposed between the upper edge of the sheet and the securing mechanism.

10. The pad of claim 1, wherein at least one of the first and second surface of each sheet comprises ink receptive coating.

11. The pad of claim 10, wherein the ink receptive coating provides release properties for the pressure sensitive adhesive.

12. The pad of claim 1, wherein the securing mechanism on each sheet is disposed generally in the same location from sheet to sheet.

13. The pad of claim 1, wherein upon flipping a first sheet in the stack over the pad causes the securing mechanism associated with the first sheet to be flipped.

14. The pad of claim 1, wherein the first and second raised elements are dried coatings of materials selected from the group consisting of ultraviolet curable coatings and water based coatings.

15. The pad of claim 2, wherein the plurality of sheets are detached from the pad and upon the gathering the detached sheets into a stack, the detached sheets are not adhesively attached to one another unless the threshold pressure has been applied to the securing mechanism.

16. An pad comprising a plurality of sheets in a stack, each sheet having opposing writeable first and second surfaces, opposing upper and lower edges, and opposing first and second sides and a selective adhesion mechanism disposed on the second side of the sheet, the selective adhesion mechanism comprising:
first and second raised elements disposed proximate to the upper edge of the sheet and generally parallel to and spaced apart form one another, each raised element having an application surface; and
a repositionable pressure sensitive adhesive having an exposed surface and disposed between the first and second raised elements,
wherein the height of the adhesive, as measured from the exposed surface of the adhesive to the second surface of the sheet is shorter than the height of either the first or the second raised element, as measured from the its application surface to the second surface of the sheet, and
wherein the first and second raised element and the adhesive are continuous from the first side to the second side edge of the sheet.

17. The pad of claim 16, wherein in the absence of a threshold level of pressure applied to the adhesive, it is spaced from a substrate and in the presence of the threshold level of pressure, the adhesive comes into securing engagement with the substrate without collapsing the first and second raised elements.

18. The pad of claim 16, further comprising at least a third raised element having an application surface and disposed between an equidistance between the first and second raised element, and wherein the height of the third raised element, as measured from its application surface to the second surface of the sheet is greater than the height of the exposed surface of the adhesive to the second surface.

19. The pad of claim 18, wherein the third raised element is selected from the group consisting of a continuous strip spanning from the first to the second edge of the sheet, a discontinuous strip, a bead, a plurality of beads, at least on rib of the sheet, at least one peak of the sheet, and combinations thereof.

20. The pad of claim 16, wherein the sheet is selected from the group consisting of paper, plastic, dry erase polymer film, canvas, fabric, and combinations thereof.

21. The pad of claim 16 further comprising a perforation disposed between the first raised element and the upper edge of the sheet.

22. The pad of claim 16, wherein the adhesive is disposed generally in the same location from sheet to sheet.

23. The pad of claim 16, wherein upon flipping a first sheet in the stack over the pad causes the securing mechanism associated with the first sheet to be flipped.

24. The pad of claim 17, wherein the plurality of sheets are detached from the pad and upon the gathering of the detached sheets to form a stack, the detached sheets are not adhesively attached to one another unless the threshold pressure has been applied to the adhesive.
